(19) United States
(12) Patent Application Publication
(10) Pub. No.: US 2014/0227675 A1
(43) Pub. Date: Aug. 14, 2014

(54) KNOWLEDGE EVALUATION SYSTEM

(71) Applicant: YourLabs, LLC, Tucson, AZ (US)

(72) Inventor: Ravi Raaj Budhu, Tucson, AZ (US)

(73) Assignee: YourLabs, LLC, Tucson, AZ (US)

(21) Appl. No.: 14/179,986

(22) Filed: Feb. 13, 2014

Related U.S. Application Data
(60) Provisional application No. 61/764,318, filed on Feb. 13, 2013.

(51) Int. Cl. G09B 7/02

(52) U.S. Cl. CPC G09B 7/02
USPC 434/362

(57) ABSTRACT

A network based electronic-learning system, especially a network based electronic-learning system to collect, process, evaluate, report, visualize, and analyze learning data from students. Instructors and students may interact with each other via a website hosted on a server. The system has an instructor dashboard, at least one instructor class room dashboard, at least one instructor assignment dashboard, a student dashboard, a student classroom dashboard, a student assignment dashboard. A library in the system is capable of storing and retrieving the classes, assignments, questions, solutions, and students' responses to solution steps and analytic widgets.

The present invention is a non-provisional patent application that claims the benefit of U.S. Provisional Application Ser. No. 61/764,318, filed Feb. 13, 2013, the disclosure of which is incorporated in its entirety herein by reference.

The present invention features a network based electronic-learning (eLearning) system, especially a network based electronic-learning (eLearning) system to collect, process, evaluate, report, visualize, and analyze learner self-reported data.

There is a growing worldwide need to gather learner data and evaluate how students learn to understand, optimize and improve learning outcomes and environments, and inform instructors. The most common way of evaluating student learning is through graded homework, quizzes, and examinations. Normally, a letter grade or a numerical score is awarded to a student.

The common way of assessing a student's performance provides little information about how a student learns, where and how mistakes are made, and whether the student really understands the concepts and problem solving methodologies required to be successful. Current assignment of letter grades is generally an aggregated weight of learning assignments at the end of a designated period, such as a semester or a year. This type of assessment provides very little room, if any, for timely instructor intervention to improve learning. In addition, no information is available for discrete tasks performed by a student during the problem solving stages to assist in improving learning outcomes.

Newer learning analysis software gather and visualize very basic intelligence data including minimum and maximum grades, average, mode, median, standard deviation, grade distribution, and social interactions within a class. Current software tools typically offer the ability to create and deliver questions and solutions to students, but only track whether or not the students input the correct answers and present the entire solution to the student. The current software tools do not have the ability to collect data on whether or not the solution and solution processes were understood or what specific steps in the solution caused learning problems. These tools do not provide discrete solution components and analytics to help pinpoint where and how a student is learning and how mistakes are made at very specific points in a given problem solving question. Moreover, they do not communicate learning outcomes or expectations to the students, which is the first step in evaluating student learning.

Current technological methodologies for creating and distributing problem solving questions to students do not have the ability to track student feedback at each step to obtain a solution.

Current learning management systems (LMS) such as Desire2Learn, Blackboard, Moodle, Sakai and Canvas allow an instructor to create and deliver questions and solutions to students, but only track whether or not the students input the correct answers and present the entire solution to the student.

Some other products, such as Pacific Metrics, develop on-line tests and record and analyze responses, but no information is available on where students are making mistakes so that corrective instructional actions can be taken. On-line K12 course providers such as K12, Inc., Apex Learning, MasteryConnect, and CompassLearning also use on-line assessment tests without getting in-depth student feedback. The company of i>clicker uses an in-class polling method either via a hardware similar to a remote controller or a software installed on the user's device. The entry for clicker is based on multiple choices or true/false or yes/no questions. It does not gather any feedback from students except for the correctness/incorrectness of the final answer.

The tools from these prior arts gather and allow for the visualization of very basic data including minimum and maximum grades, average, mode, median, standard deviation, grade distribution, and social interactions within a class. They provide summative assessments or simple formative assessments, but do not provide discrete solution components and analytics to help pinpoint how a student is learning and where and how mistakes are made at very specific points in, for example, a given problem solving question. Also, they generally do not communicate learning outcomes or expectations to the student, which is the first step in evaluating student learning. The proposed tool has the ability to collect data on whether or not the solution and the solution process were understood, what specific steps in the solution caused learning problems, and the reasons for the learning problems.

Hence, there is a need for a system that allows an instructor to collect, process, evaluate, report, visualize student submission self-reported data, and analyze learner self-reported feedback based on problem solving questions and analytic widgets that the instructor created, adopted or modified. The invention utilizes the learner self-reported data and conducts analyses to discover connections, contexts, learning styles, etc. to better understand how students learn and to provide an instructor with opportunities to make customized adjustments in teaching models to improve and optimize learning.

### BRIEF SUMMARY

The present invention features a network based electronic-learning (eLearning) system, especially a network based electronic-learning (eLearning) system to collect, process, evaluate, report, visualize, and analyze learner self-reported data. Instructors and students may interact with each other via a website hosted on a server.

In some embodiments, students and instructors sign-in or register with the eLearning system via the registration page of the site. Registration comprises entering the user's first name, last name, email address, password, learning institution, and role (student or instructor) into a web-based form. Optionally, a cellular phone number, cellular phone service provider, and Twitter (or similar social network) username can be entered into the form. When the form is submitted, the form information is validated and stored in a database on the web server.

An instructor can create questions on a network site (such as a networking dashboard) using a question creation module of the present invention (henceforth known as the Question Creator). The Question Creator is a web-based form which allows the instructor to do a variety of question creation functions.

The system includes a server, at least one user terminal operatively connected to the server. In some embodiments, the user terminal is a computer, laptop, tablet, or a smartphone. In some embodiments, an application is installed within the user terminal. The user (both the instructor and student) may visit the server via the user terminal.

Examplenary infrastructure to implement the above feature includes a website hosted on a server and at least one user terminal on a user's side, such as a desktop, a laptop, a smartphone. The server comprises at least a server microprocessor, a server storage (to store website software code, associated files and user information), a server network communication hardware, such as Ethernet card, wireless internet adapter, etc. The server microprocessor is operatively connected to the server memory and the server internet communication hardware. The user terminal comprises a display, a client microprocessor, a client storage, an input means (such as touch screen input or keyboard input), a client network communication hardware and an optional speaker (or audio output jack). The client microprocessor is operatively connected to the display, the client storage, the input means, the speaker and the client internet communication hardware. The server network communication hardware and the client network communication hardware are operatively connected such that the server's information is transferable to the client terminal and the user's input/interaction is transferable to the server and saved within the server memory. In some embodiments, the server network communication hardware and the client network communication hardware are operatively connected through internet or intranet via various protocols, such as http, https, ftp, or any other commonly uses networking application protocols.

It has been outlined, rather broadly, the more important features of the embodiments of the system and method of the network based electronic-learning (eLearning) system in order for the detailed description thereof that follows may be better understood, and in order for the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION

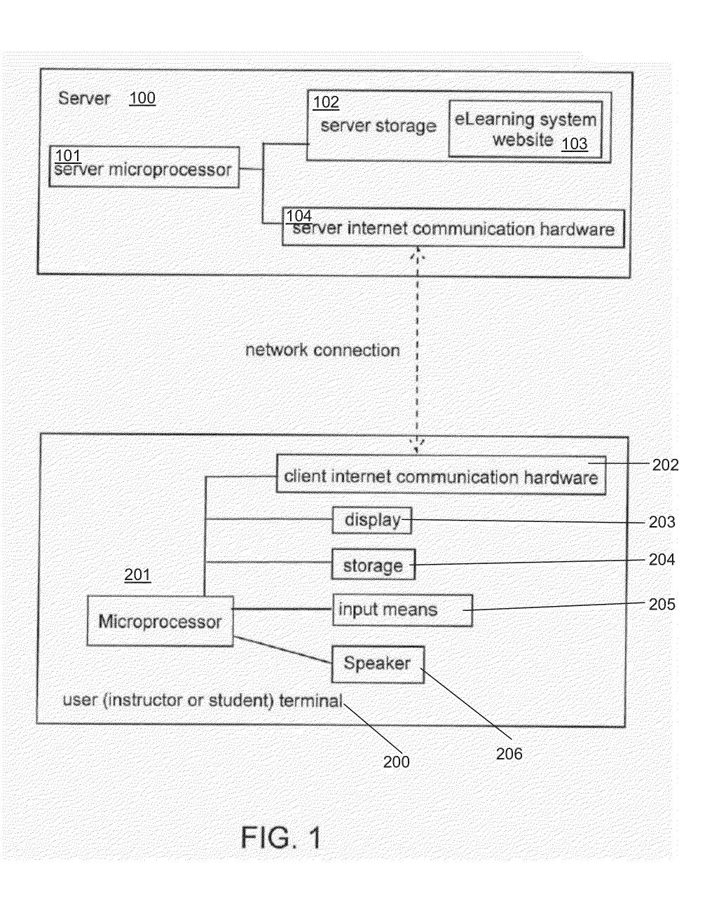

FIG. 1 shows a schematic view of the eLearning system.

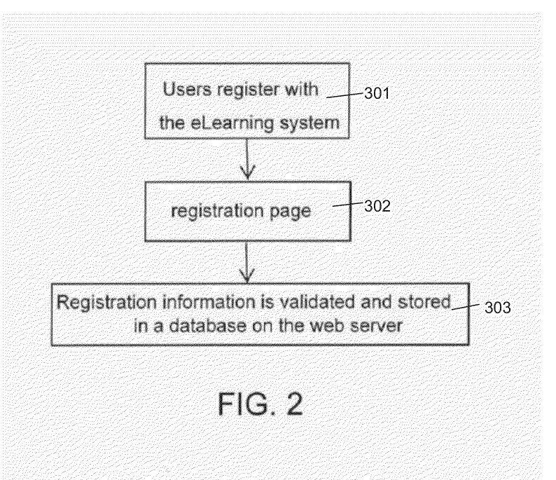

FIG. 2 shows a flow chart for user registration with the eLearning system.

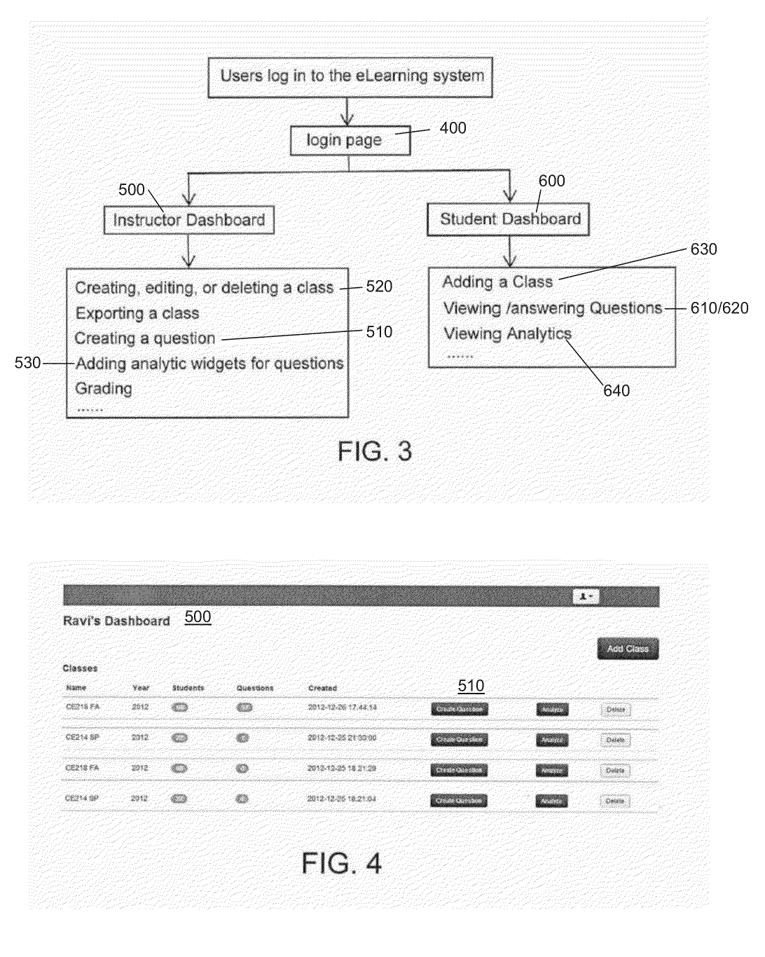

FIG. 3 shows a flow chart for user login to the eLearning system

FIG. 4 shows an exemplary instructor dashboard interface.

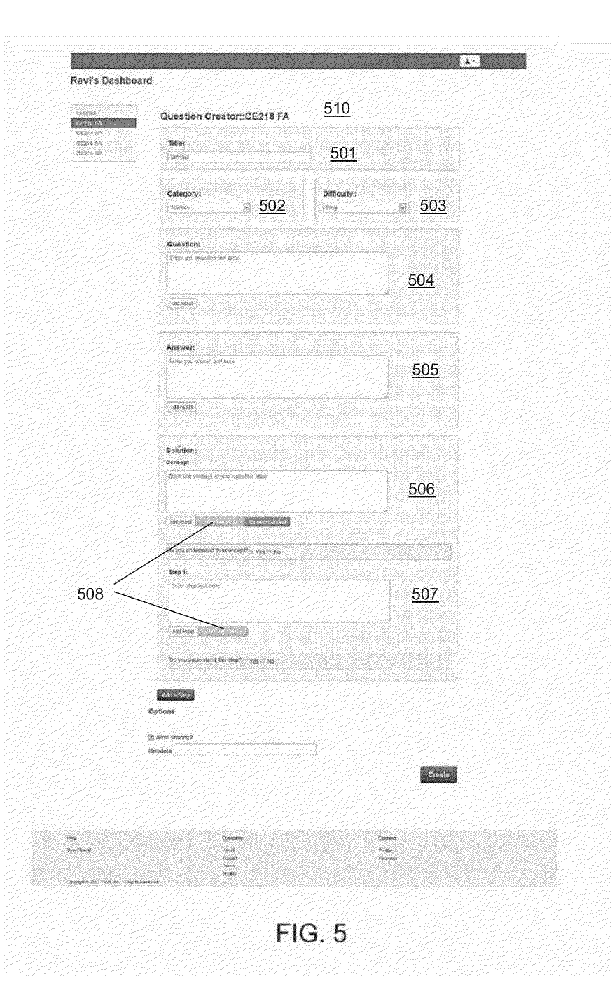

FIG. 5 shows an exemplary question creation interface.

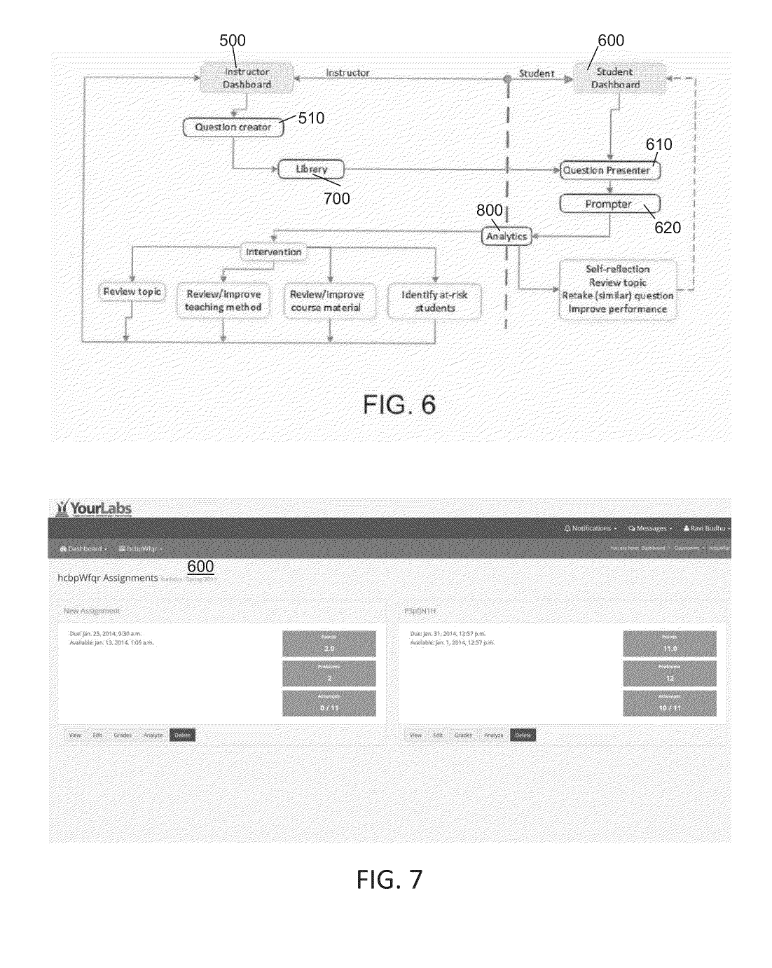

FIG. 6 shows an exemplary workflow of the eLearning system.

FIG. 7 shows an exemplary instructor classroom dashboard.

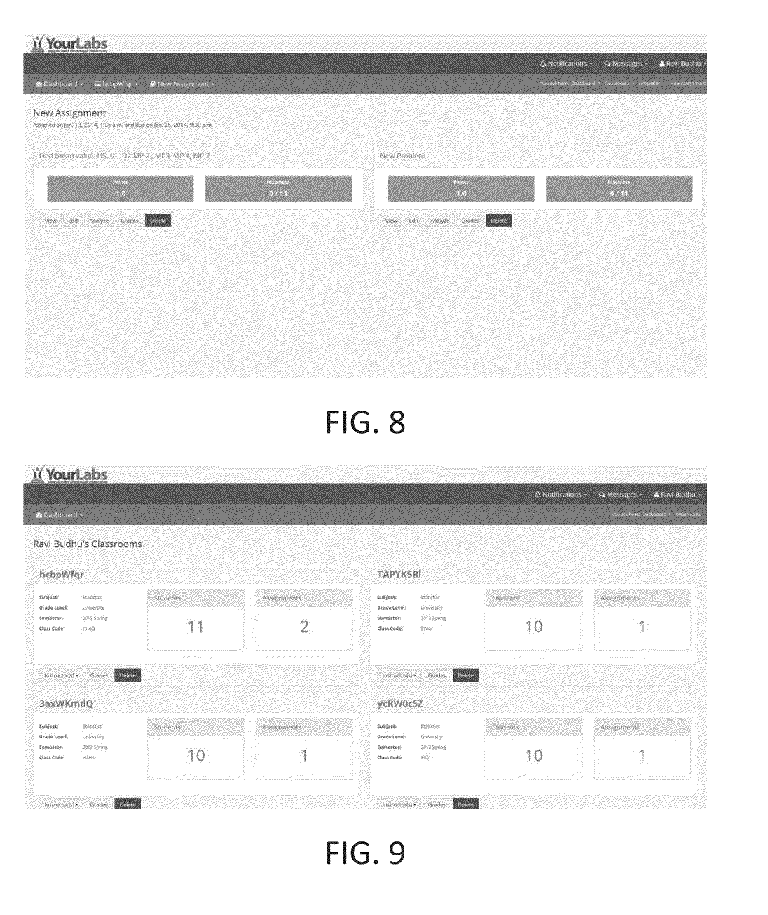

FIG. 8 shows an exemplary assignment dashboard.

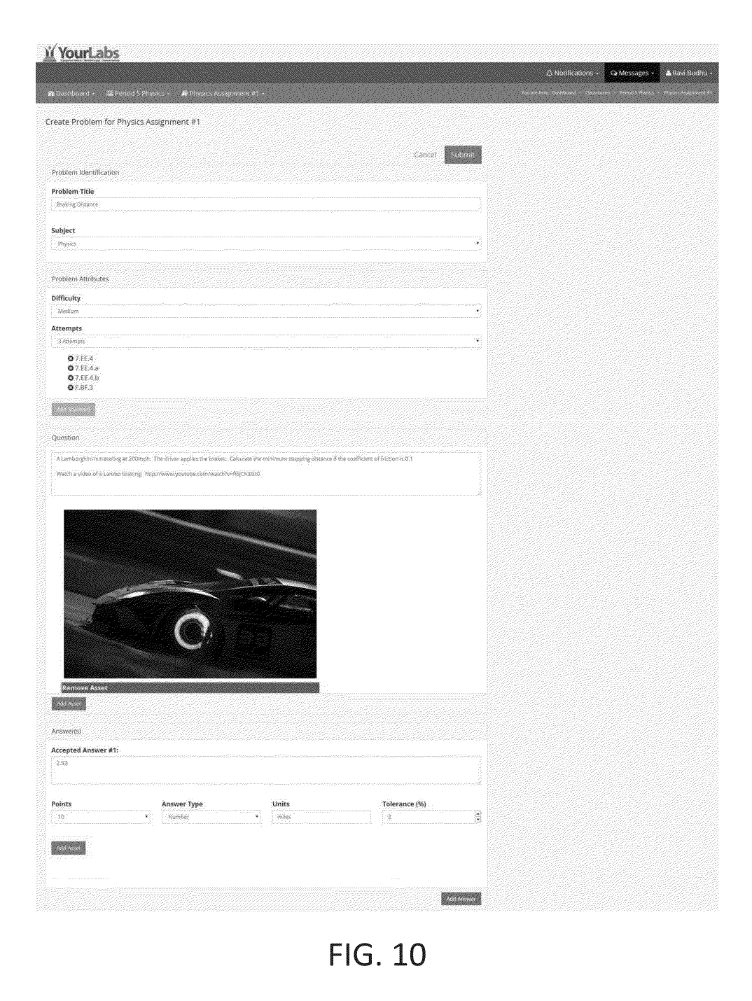

FIG. 9 shows an exemplary instructor dashboard.

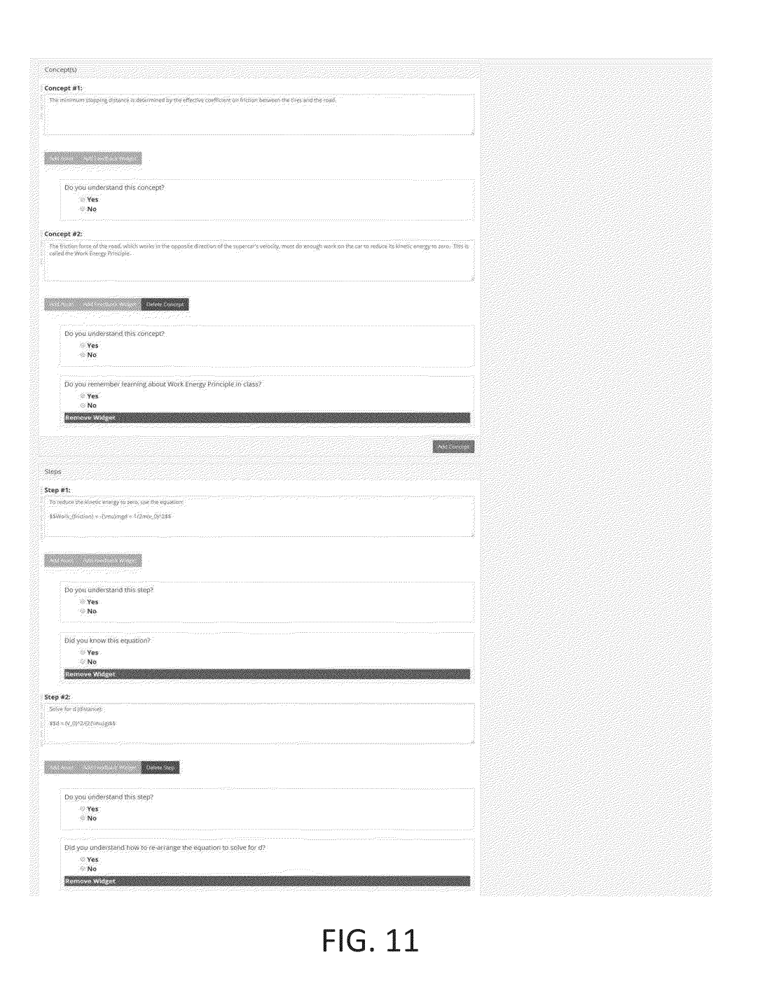

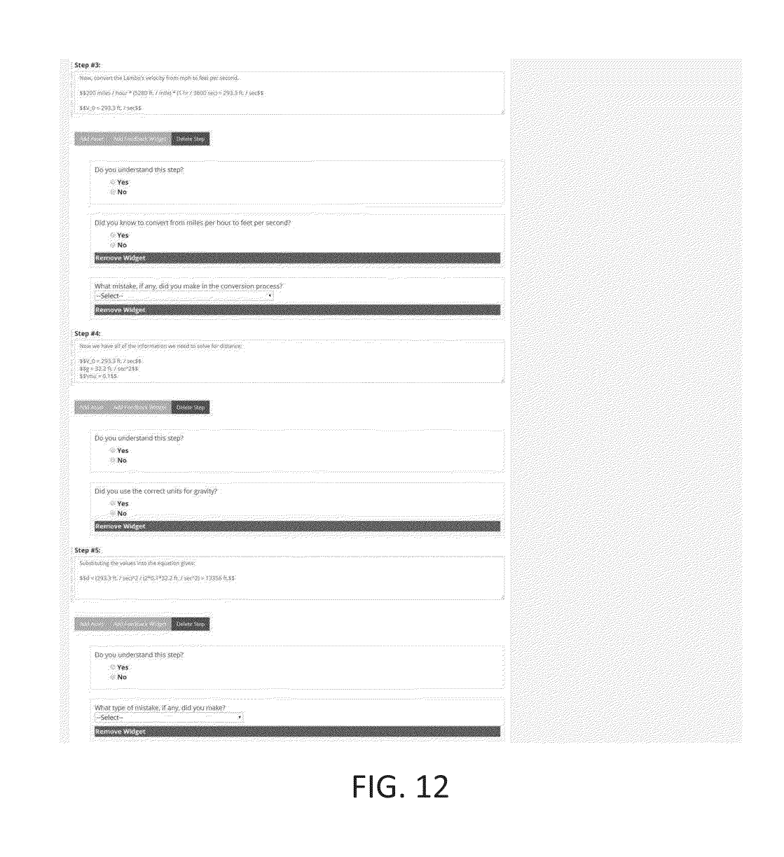

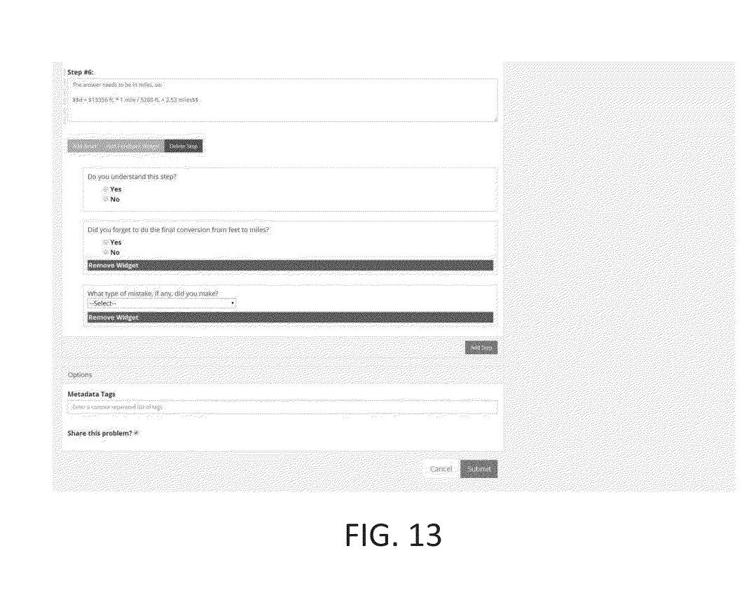

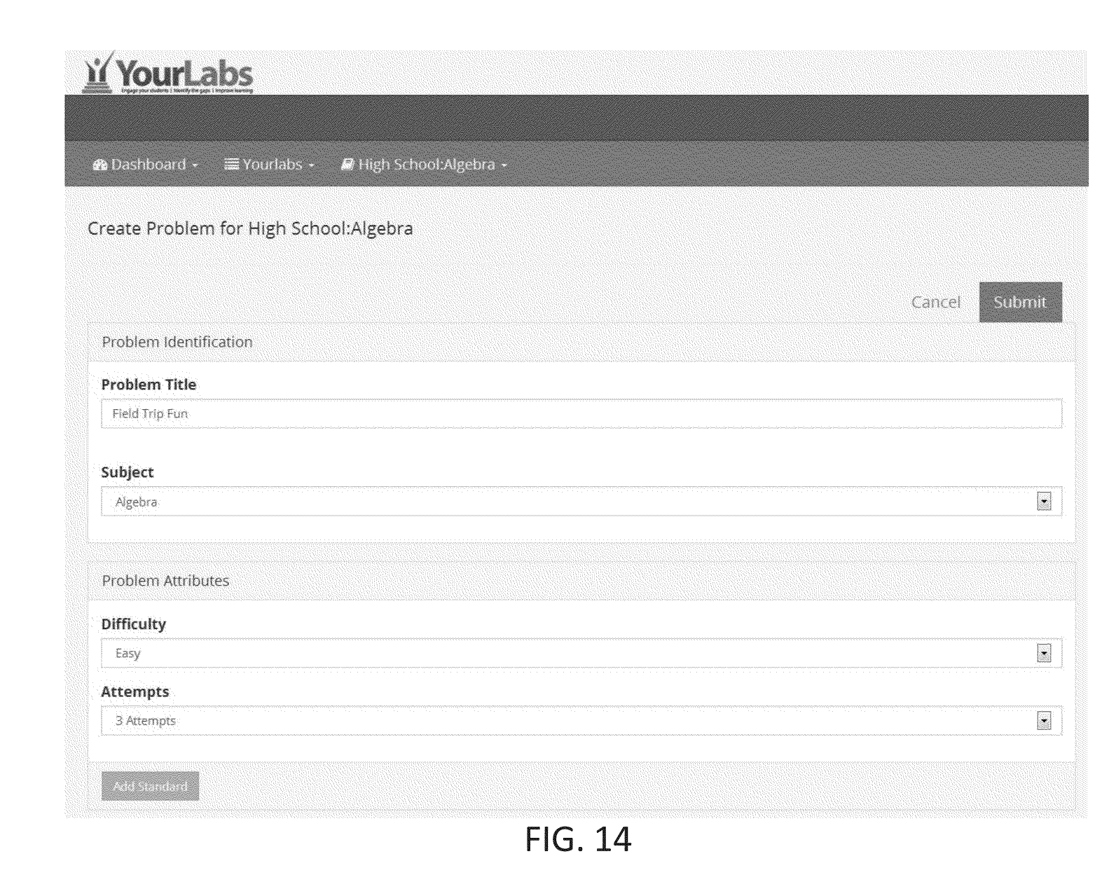

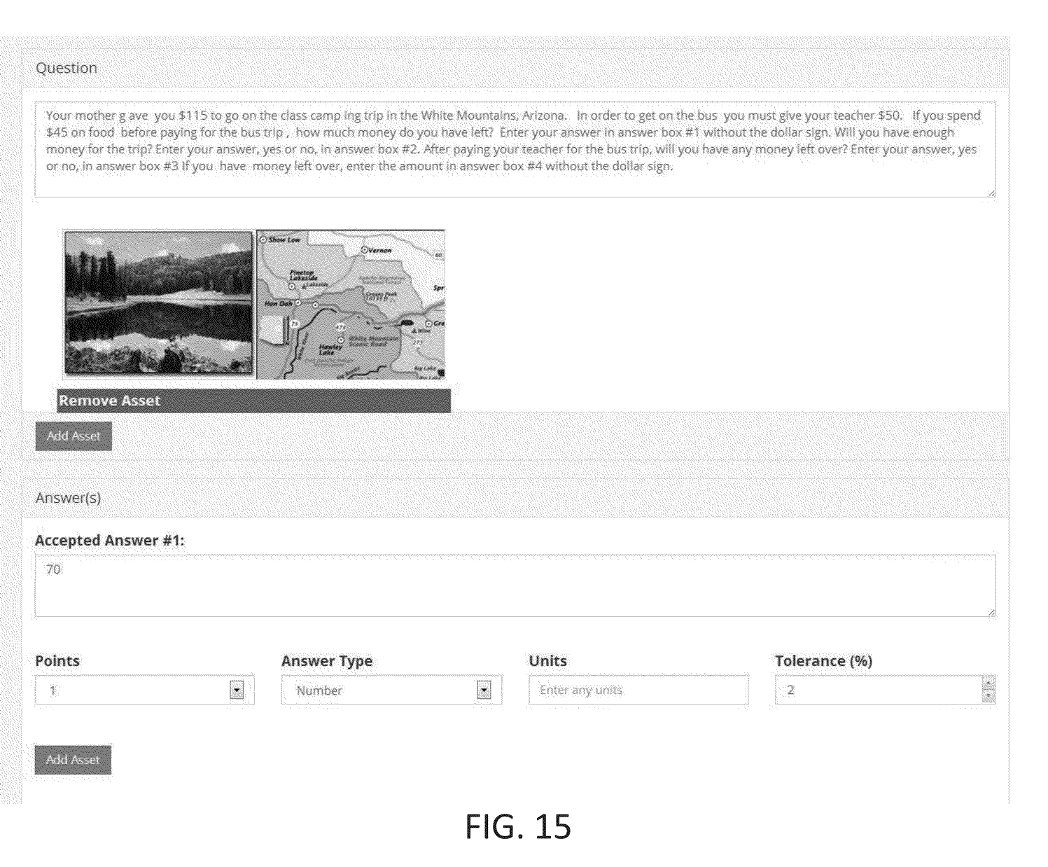

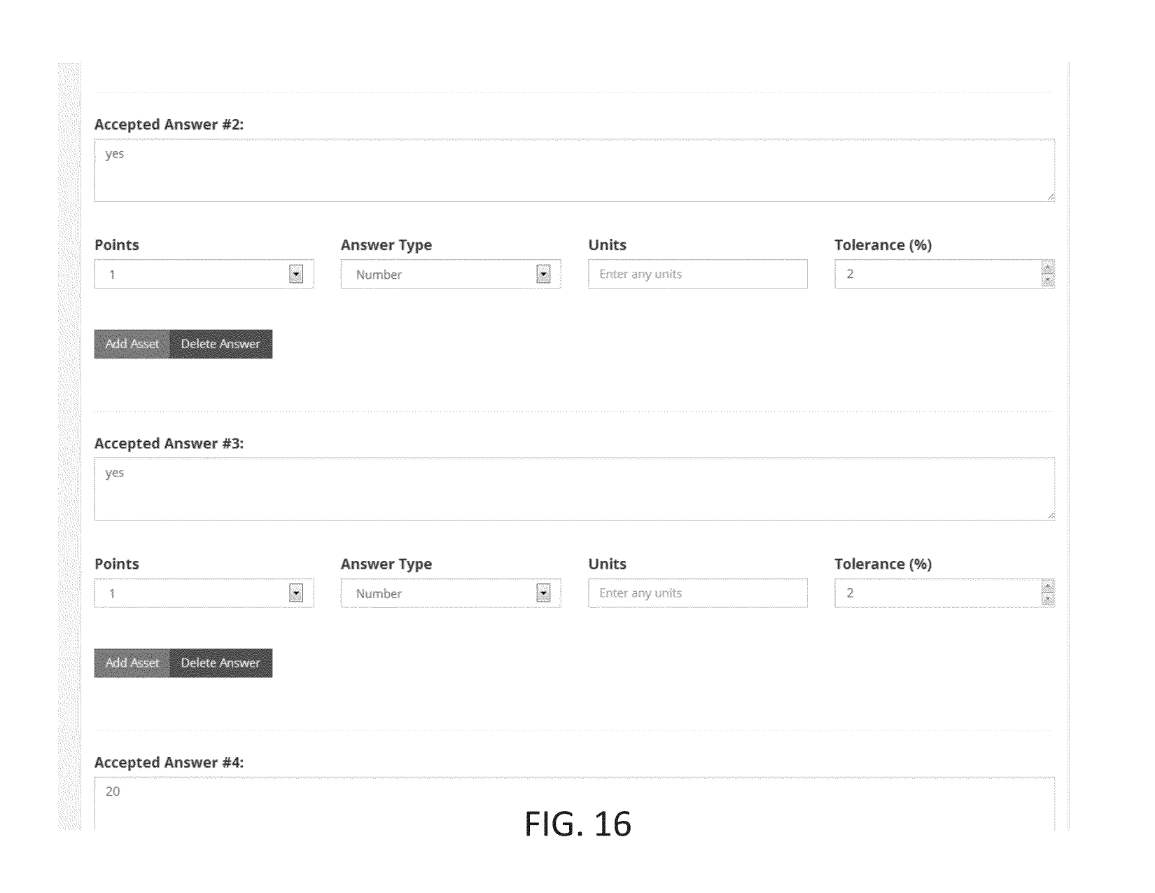

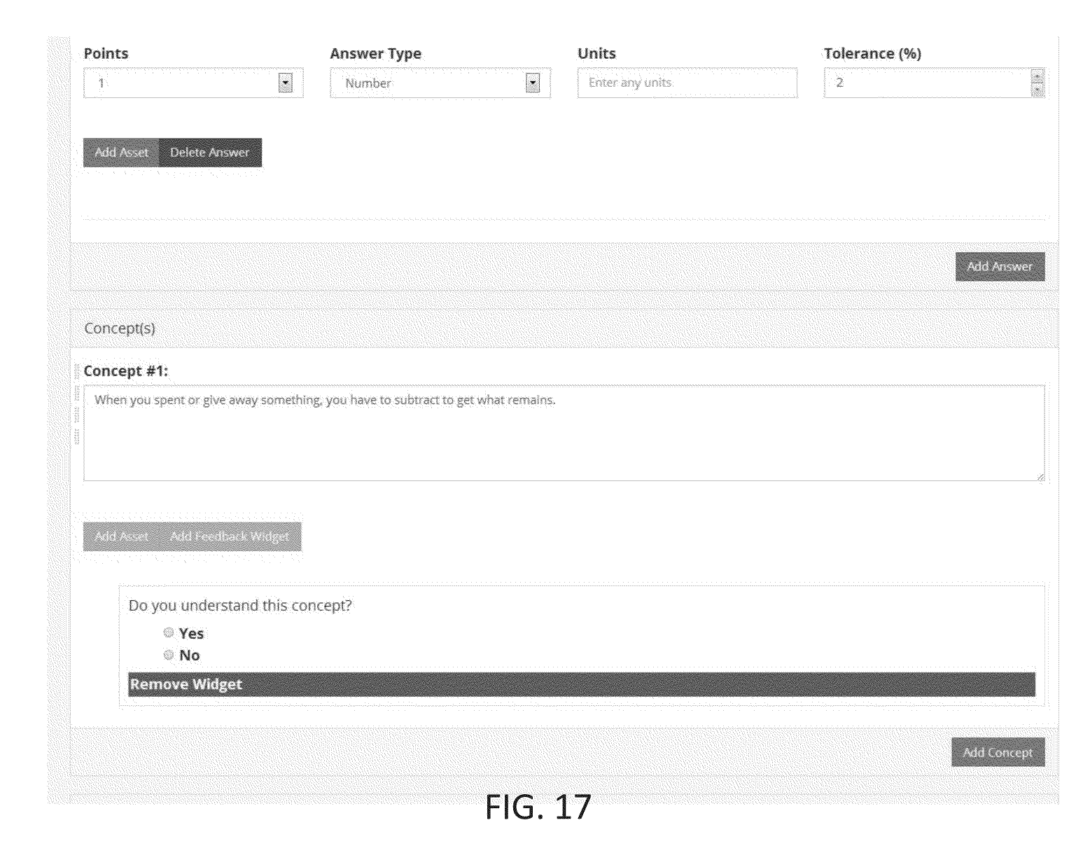

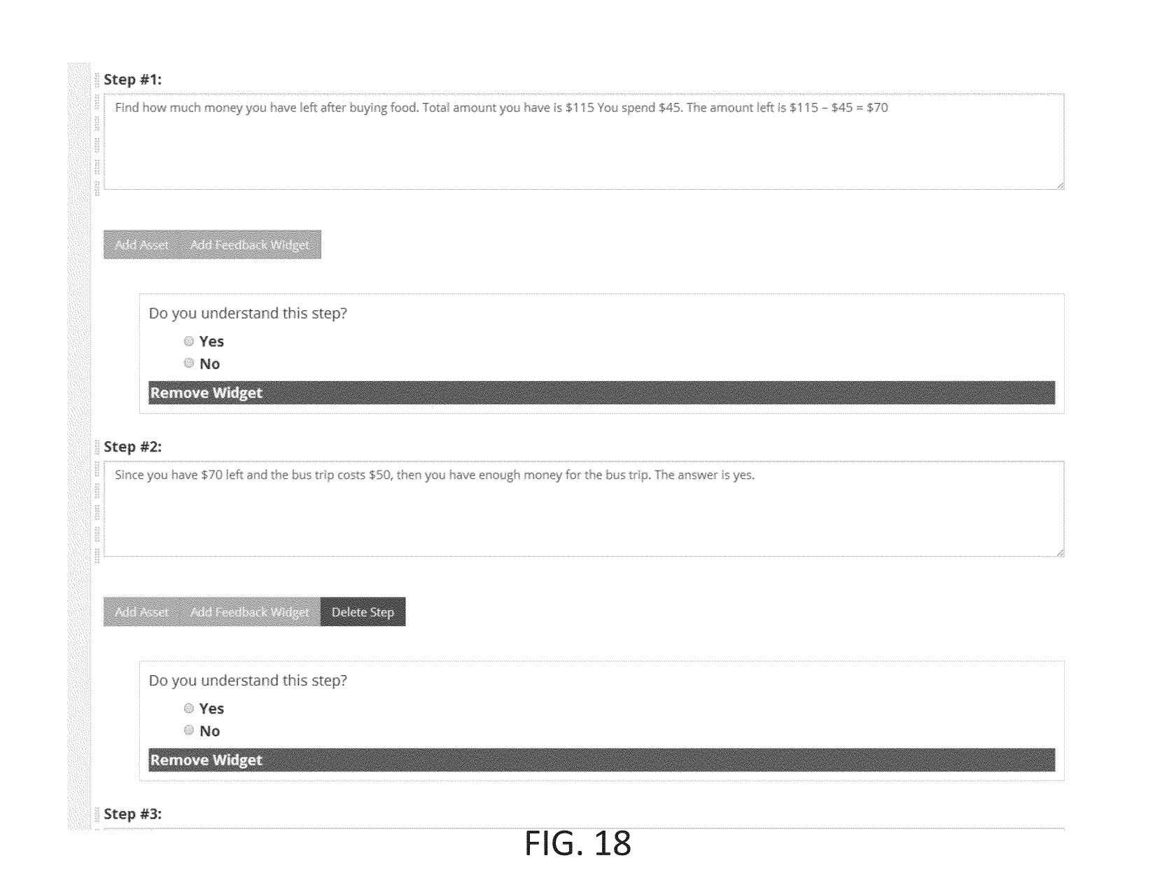

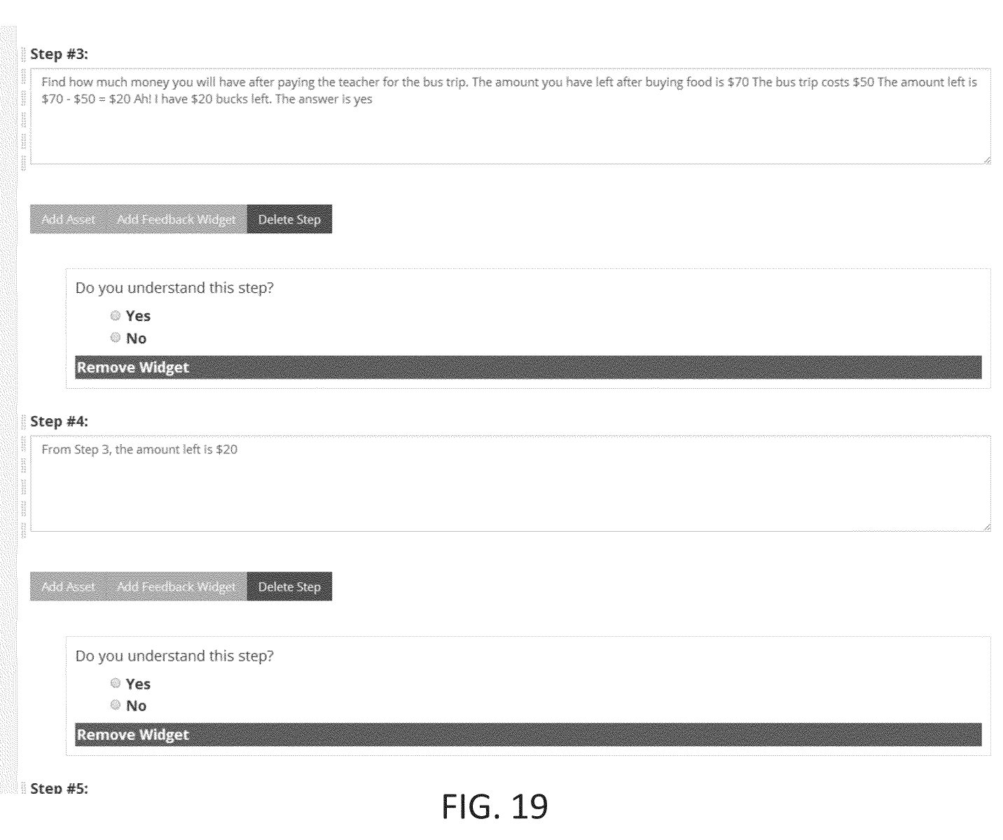

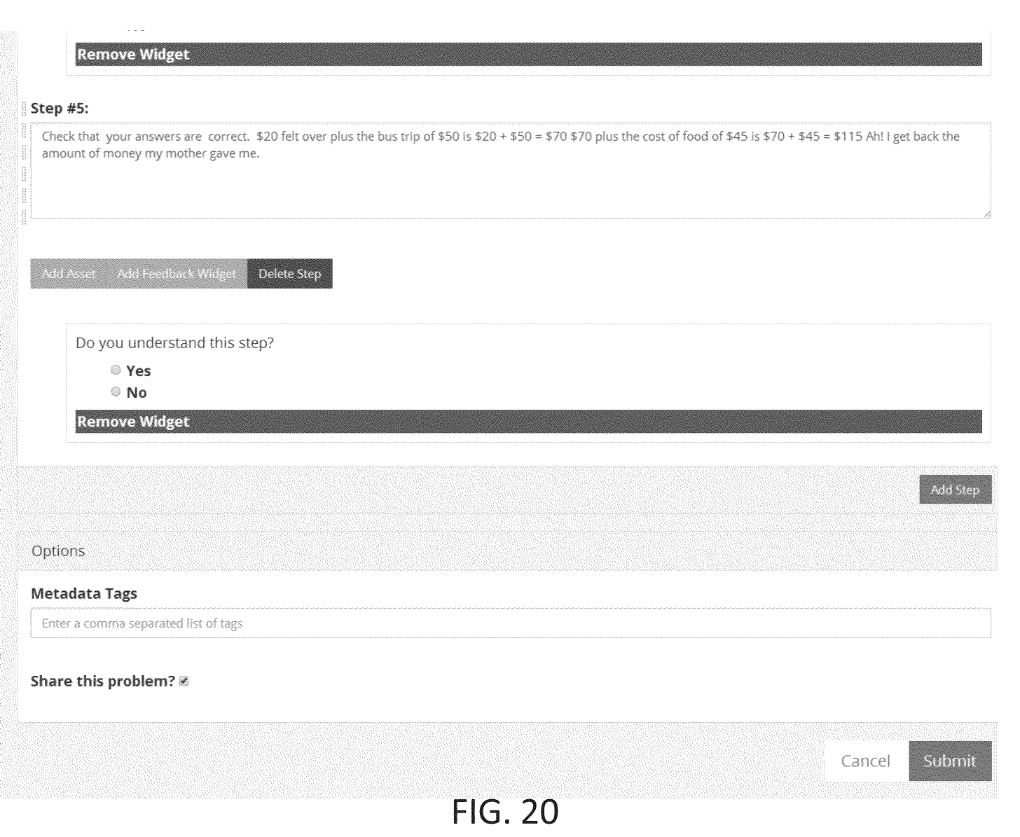

FIGS. 10-20 show an exemplary question creation form.

### DESCRIPTION OF PREFERRED EMBODIMENTS

Referring now to FIG. 1-20, the present invention features a network based electronic-learning (eLearning) system, especially a network based electronic-learning (eLearning) system to collect, process, evaluate, report, visualize, and analyze learner self-reported data. Instructors and students may interact with each other via a website hosted on a server.

First, students and instructors need to sign-in or register with the eLearning system 301 via a registration page 302 of the site. Registration comprises entering the user's first name, last name, email address, username, password, and role (student or instructor) into a web-based form. Optionally, a cellular phone number, cellular phone service provider, and TWITTER (or similar social network) username can be entered into the form. When the form is submitted, the form information is validated and stored in a database on the web server 303.

Users log in to the eLearning system via a login page 400 of the site. Logging in comprises entering the user email address and password (credentials), input and stored during the sign-up/registration process, into a web-based form. When the form is submitted, the form information is validated and the credentials are checked against a database on the web server to see if the user has successfully registered. If so, the user is directed to an appropriate dashboard page depending on their role. If the user is not verified in the database, they are directed back to the log in page. Optionally, the user can reset his or her password in the event that he or she forgot it.

In some embodiments, users that are logged in to another learning management system like Desire2Learn or Blackboard, can log into the system automatically through Security Assertion Markup Language, OAuth, or other single sign-in authentication methods.

Instructor Dashboard

Users logging in with the instructor role are directed to a web page titled Instructor Dashboard 500. An exemplary instructor dashboard interface is shown in FIG. 4. The Instructor Dashboard allows an instructor to manage his or her classes including: (1) Creating, editing, exporting, and deleting a class 520; (2) Creating, editing, deleting, publishing, exporting, and sharing an assignment, (3) Creating, editing, deleting, publishing, exporting, and sharing a problem solving question 510; (4) Viewing all classes associated with the currently logged-in instructor; (5) Viewing, editing, deleting all students associated with each class; (6) Analyzing, sharing, exporting student knowledge mastery and self-reported feedback; (7) Contacting students via email, Twitter, or text message. Details of some functions are explained in following paragraphs.

Creating a Class

Instructors click on a button on the Instructor Dashboard to add a class to the dashboard. Adding a class comprises entering a class name, a unique alphanumeric class code into a form and selecting an institution from a dropdown list, entering or selecting a semester, grade level, subject, and/or year. If an institution is not found in the dropdown list, one can be added by entering the institution's name, address, phone, district, country, county, and URL. Each institution is stored in a database with geo-spatial information which includes, but is not limited to, the latitude and longitude coordinates of its location on Earth. When the form is submitted, the form information is validated and stored in a database on the server. The class is then added to the Instructor Dashboard as a hyperlink.

Editing a Class

Instructors click on the hyperlink of the class they wish to edit from the Instructor Dashboard. The instructor is directed to the class page where there is a hyperlink or button that directs them to a page with a form where they can edit and re-submit the class information.

Deleting a Class

Instructors click on the hyperlink of the class they wish to delete from the Instructor Dashboard. The instructor is directed to the class page where there is a hyperlink or button that directs them to a page with a form where they can delete the class and all associated information.

Exporting a Class

Instructors click on the hyperlink of the class they wish to export from the Instructor Dashboard. The instructor is directed to the class page where there is a hyperlink or button that directs them to a page with a form where they can export the class and all associated information in various output formats including, but not limited to, comma separated value (CSV) or plain text.

Instructor Assignment Dashboard

An exemplary instructor assignment dashboard interface is shown in FIG. 8. The Instructor Assignment Dashboard allows an instructor to manage his or her assignments including: (1) Creating, editing, exporting, and deleting an assignment; (2) Creating, editing, deleting, publishing, exporting, and sharing an assignment, (3) Creating, editing, deleting, publishing, exporting, and sharing a problem solving question; (4) Viewing all classes associated with the currently logged-in instructor; (5) Viewing all students associated with each class; (6) Analyzing, sharing, exporting student knowledge mastery and self-reported feedback; and (7) Contacting students via email, TWITTER, or text message. Details of some functions are explained in following paragraphs.

Creating an Assignment

Instructors click a hyperlink on the Instructor Classroom dashboard to create an assignment. Creating an assignment comprises entering an assignment name, a start date, and an end data into a form.

Editing an Assignment

Instructors click on the hyperlink of the assignment they wish to edit from the Instructor Classroom Dashboard. The instructor is directed to the assignment page where there is a hyperlink or button that directs them to a page with a form where they can edit and re-submit the assignment information.

Deleting an Assignment

Instructors click on the hyperlink of the assignment they wish to delete from the Instructor Classroom Dashboard. The instructor is directed to the assignment page where there is a hyperlink or button that directs them to a page with a form where they can delete the assignment and all associated information.

Exporting an Assignment

The instructor clicks on the hyperlink of the assignment he/she wishes to export from the instructor Classroom Dashboard. The instructor is directed to the class page where there is a hyperlink or button that directs them to a page with a form where they can export the assignment and all associated information in various output formats including, but not limited to, comma separated value (CSV) or plain text.

Sharing and Collaborating an Assignment

The instructor clicks on a hyperlink of the assignment he/she wishes to share and collaborate with others anywhere in the World from the Instructor Classroom Dashboard. The instructor completes sending the information such as email addresses.

Sharing and Collaborating a Classroom

The instructor clicks on a hyperlink of the Classroom he/she wishes to share and collaborate with others anywhere in the World from the Instructor Classroom Dashboard. They instructor completes sending the information such as email addresses.

Question Creator

An instructor can create a question using the question creation module of the present invention (henceforth known as the Question Creator). An exemplary question creation interface is shown in FIG. 5, and in FIGS. 10-20. The Question Creator is a web-based form with the following inputs:

1) Question title 501

2) Question subject

3) Question attributes 502

4) Question text 504

5) Question answer (one or more) 505

6) Question learning outcome/concept (if any; one or more)

7) Step-by-step question solution 506

8) Question difficulty rating 503

9) Assets such as images, videos, documents and similar to inputs 2, 4 through 7

10) Analytic widgets to inputs 4 and 7. 508

For inputs 2, and 4 through 7, an instructor can add hyperlinks, graphics, sounds, mathematical equations, embedded HTML, video, and other multimedia components from external sources or from eLearning system asset libraries. An instructor can add multiple steps that describe how to find the problem solution and each step can have hyperlinks, graphics, sounds, mathematical equations, embedded HTML, video, and other multimedia components from external sources or from eLearning system asset libraries. In addition, an instructor can import a Microsoft Word document based on a provided template which, when parsed by the invention, will automatically fill in inputs 1 through 6 including text, images, and mathematical equations.

For input 3, an instructor can select a question difficulty (easy, medium, hard) and the number of attempts a student can make for the question (1 through unlimited). In addition, the instructor can add one or more standards such as Common Core State Standards or ABET standards to a question. Instructors can select standards from a dropdown list or search for standards using keywords. New standards can be imported into the system using formats like comma separated value files (CSV).

For input 5, the answer can be any type including text, number, or equation. The instructor can enter the number of points the answer is worth, the answer type (text, number, or equation), the units the answer should be in, and a tolerance value (percentage) that defines the acceptable range of answers for the question.

The instructor can add multiple analytic widgets 508 to inputs 4 through 7. An analytic widget is an HTML form element such as radio buttons, checkboxes, or dropdowns that tracks where students made errors and what types of errors were made at each step of the solution. The instructor can assign custom labels and options to the analytic widget depending on the learning outcomes or common student mistakes that can be made at each part of the solution. For example, if the instructor knows that on step 3 of the solution to a problem, most students typically either use the wrong equation to calculate the result at that particular step, make an arithmetic error, or make a sign error, he or she can create an analytic widget that allows the student to select which mistake he or she made at that step. The student does not have to follow each step of the prepared solution in his/her solution. The steps provide a means for capturing where mistakes are made and to show students a logical way of solving the problem.

The instructor can select pre-existing widgets from the invention's library of widgets or create his or her own for a selected part of the solution. An analytic widget is created via a form with inputs for widget title, widget label/text, widget options, and widget description. When the form is submitted, the input is transformed into an HTML element that is then appended to the selected part of the solution. Multiple analytic widgets can be selected from a library or created and attached to a solution element.

When the instructor finishes the creation of the question and attaching analytic widgets to particular solution elements, the form can be submitted and the question and all components of the question are stored in a database. The question is then viewable on the Instructor's and Students' Dashboards. A hyperlink to the question is also generated and can be distributed to students or shared or embedded in other applications.

When a student visits a question via the Student Dashboard 600 or by following a hyperlink to the question, he or she is presented with the question text and an input area for the answer within a form element 610. The student inputs the answer to question and submits the form. The student's answer is compared to the answer stored in the database for the particular question. The student is presented with a new page 620 that displays whether or not he or she got the question correct and what was the correct answer. The student is then presented with the learning outcome/concept behind the question, while all other parts of the solution are initially hidden. The outcome/concept behind the question gives an instructor the opportunity not only to state learning outcomes or objectives but to re-present the important concepts/principles for learning reinforcement. To view the next part of the solution, the student must answer all analytic widgets attached to the preceding solution element. This incentivizes the student to self-report any mistakes made and supports self-regulated learning strategies. If the student made an error that is not an option in an analytic widget, the student is able to input free text in a text area per step to describe what error he or she made or describe alternative methods for solving the problem.

The responses to the analytic widgets are stored in a database 700 with an associated timestamp. The responses to the analytics are associated with a user who is associated with a class that is associated with an instructor and institution. When the student has answered the last analytic widget (if any) of the last solution element of the problem, he or she can click a HTML form element to view the analytics associated with the question for the entire class. The student can assess how he or she performed relative to his or her peers and make self-regulated learning adjustments as necessary. In addition, the student can rate the difficulty of the question and choose to perform another similar question.

The analytics 800 component of the invention can support multiple types of analytics. In some embodiments, currently available analytics include:
1. A frequency chart of the answers submitted. This plot shows the various answers that were submitted and the percentage of students that submitted each answer.
2. The mean, mode, standard deviation, maximum, and minimum scores for a problem.
3. The percentage of students who got the problem right or wrong.
4. A table of how long it took each student to answer the question with rows containing students who answered the question correctly highlighted in a different color from other rows.
5. A chart of the percentage of students who understood the learning outcome/concept behind the question (if any).
6. A chart of the percentage of students who understood each step of the solution.
7. Charts of the percentage of students that made each type of error associated with an analytic widget (which in turn is associated with a particular step).
8. Historical/trend analytics showing how students performed on groups of questions over a period of time.
9. Location analytics showing plots of location versus student performance.
10. Temporal analytics charting student performance as a function of the time of day they attempted the problem.
11. Difficulty rating of a problem by students and the instructor is compared.

By analyzing and interpreting this data, instructors can determine the success factors for their class and future classes, and make modifications to teaching strategies, course content and curricula Educational administrators and policy makers can view and compare performances among each student, each teacher, each class, and each school.

Student Dashboard

Users logging in with the student role are directed to a web page titled Student Dashboard 600. The Student Dashboard allows a student to manage his or her classes including, but not limited to, adding himself or herself to an existing instructor created class; viewing and answering problem solving questions; and viewing analytics for problem solving questions.

Adding a Class

Students click on a button on the Student Dashboard to add a class to the dashboard. Adding a class comprises entering an alphanumeric class code provided by an instructor into a form. When the form is submitted, the form information is validated and the student is added to the class with the associated class code. The class is then added to the Student Dashboard as a hyperlink.

Viewing and Answering Questions

Students click on the class they wish to view problem solving questions for from the Student Assignment Dashboard. The student is then presented with the page for that class and a list of problem solving questions associated with the class as hyperlink. The student can click on a question to view and answer it.

Viewing Analytics

Students click on the class that they wish to view problem solving questions from the Student Dashboard. The student is then presented with the page for that class and a list of problem solving questions associated with the class as hyperlink. If the student had previously attempted the question, he or she can view the analytics associated with the question by clicking a hyperlink. If the question had not been attempted, the student must attempt the question to be able to view any analytics.

Grading

For grading, an instructor can assign a single percentage for completely correct answers or partial credit based on student self-reported errors.

The following is a short summary of the key advantages of the present invention;
1. Discrete single or multi-step problem solutions.
2. The ability to add student self-reporting analytic widgets to each step to capture where and how students make mistakes.
3. The ability to hide parts of a solution until the student responds to an analytic widget.
4. The ability to import Microsoft Word templates into the question creator and automatically fill in the required fields, import text, images, and embed Microsoft Word equations into the question as standard MathML.
5. The ability to view student self-reported feedback at various points in the problem solution.
6. The ability for student to monitor their performance in courses compared to peers.
7. The ability to perform spatial and temporal analytics on learner provided data to evaluate learning outcomes.
8. The ability to provide learner data and analytics to modify learning objects, learning contents, and curricula to improve learning outcomes.
9. The ability to evaluate how learning changes with time.
10. The ability to identify groups of students with special learning needs for timely intervention.
11. The ability to give partial credit for incorrect answers.
12. Provides a linkage between learning objectives and evaluation by matching cognitive levels and the topic defined by the learning objectives
13. The ability to add rich content such as videos, sound, images, documents and similar to questions, concepts and solution steps to provide context to problem solving and enrich the learning experience.

Work Flow of the System

An exemplary workflow of the eLearning system is shown in FIG. 6. As shown in FIG. 6, the system allows an instructor to collect, process, evaluate, report, visualize, and analyze the student's knowledge and mastery of the subject and learner self-reported feedback based on instructor created, adopted or modified (problem solving) questions and analytic widgets. This tool will have a distinct advantage over existing tools because it will operate in real time and get actionable knowledge-based information such as whether a student understands a concept, what mistakes a student makes, at which point in problem solving mistakes are made, and how long the student takes to answer a question compared to his or her peers. The data and the generated analytics will allow an instructor to discover connections, contexts and learning styles to better understand how students learn and to provide opportunities to make timely interventions and to customize adjustments in teaching practice and identify at-risk students. Similarly, the analytics will allow a student to self-reflect on his/her performance and take remedial actions. The tool will work on any internet connected device such as smartphones.

The present system also provides students with actionable information on their performances in comparison with their peers, allows them to view solution methodologies and the concepts associated with the questions or activities, and take corrective action. In addition, this tool will conduct analyses to discover connections, contexts, and learning styles to better understand how students learn and to provide an instructor with opportunities to make timely interventions and to customize adjustments in teaching models to improve and optimize learning.

The System Features Five Key Components:
1. A Question and solution creator 510, referred as Question Creator, creates a question and its solution to evaluate a particular or any number of learning outcomes tied or separated from a course topic. An exemplary question creation interface is shown in FIG. 5
2. A question presenter 610, referred as Question Presenter, displays the question to the learner and to receive learner responses or answers.
3. A solution prompter 620, referred as Prompter, interactively presents the solution to a problem, interrogate the learner via customized widgets, retrieve and store learner reported data.
4. A question and solutions library 700, referred as Library, allows for the storage, retrieval, display and manipulation (e.g. cloning) of private or shared questions and analytics on a particular topic or sets of topics.
5. An analytics creator 800, referred as Analytics, facilitates the creation and display of multiple types of analytics based on learner self-reported data.

The integration of the five key components is shown in FIG. 6. The flow chart (FIG. 6) shows how instructors can actively learn from students' feedback to improve educational practice and enhance learning outcomes and how students can reflect on their current performances and make self-improvements.

The Instructor Dashboard 500 allows an instructor to manage his or her classes including, but not limited to creating, editing, exporting, and deleting a class; creating, editing, deleting, publishing, exporting, and sharing a problem solving question or an activity; viewing all classes associated with current log in; setting grading and difficulty level; viewing all students associated with each class; analyzing, sharing, exporting student knowledge mastery and self-reported feedback, and contacting students via email, Facebook, TWITTER, or text message. Current learning management system such as Blackboard (http://www.blackboard.com) or Desire2Learn (http://www.desire2learn.com) will be integrated through application programming interface (API) or through the importationlexportation of students' data in formats such as comma separated value (CSV) or plain text.

The Instructor Classroom Dashboard allows an instructor to manage his or her assignments including, but not limited to creating, editing, exporting, and deleting an assignment, creating, editing, deleting, publishing, exporting, and sharing a problem solving question or an activity; viewing all assignments associated with current log in; setting grading and difficulty level; viewing all students associated with each assignment; analyzing, sharing, exporting student knowledge mastery and self-reported feedback, and contacting students via email, Facebook, Twitter, or text message.

The Question Creator 510 is a web-based form to create or clone or import a question or activity. In its basic format, it has a question title, question subject, question attributes, question text, question answer(s), question learning outcome(s)/concept(s) (if any), step-by-step solution, difficulty rating and meta-data. An instructor is able to add hyperlinks, graphics, sounds, mathematical equations, embedded HTML, video, and other multimedia components from external sources or from the tool's asset library. Multiple steps can be added that describe how to find the problem solution and each step can have hyperlinks, graphics, sounds, mathematical equations, embedded HTML, video, and other multimedia components from external sources or from the tool's asset library. In addition, an instructor can import a Microsoft Word document based on a provided template which, when parsed by the proposed application, will automatically fill in text, images, videos and mathematical equations in the set format. This template is an important element in the Question Creator because it significantly reduces the time it takes to prepare or edit questions, especially for questions that contain mathematical equations and/or special symbols.

For question attributes, an instructor can select a question difficulty (easy, medium, hard) and the number of attempts a student can make for the question (1 through unlimited). In addition, the instructor can add one or more standards to a question. Standards include Common Core State Standards or ABET standards. Instructors can select standards from a dropdown list or search for standards using keywords New standards can be imported into the system using formats like comma separated value files (CSV).

For each answer in the question solution, the answer can be any type including text, number, or equation. The instructor can enter the number of points the answer is worth, the answer type (text, number, or equation), the units the answer should be in, and a tolerance value (percentage) that defines the acceptable range of answers for the question.

For each step, an instructor can add multiple customized analytic widgets (an analytic widget will be an HTML form element with radio buttons, checkboxes, or dropdowns as appropriate) that track where students made errors, what types of errors were made at each step of the solution, and students' voluntary comments on each step. The instructor can assign custom labels and options to the analytic widget depending on the learning outcomes or common student mistakes that can be made at each part of the solution. For example, if the instructor knows that at step 3 of the solution to a problem, most students typically either use the wrong equation or make a sign error, he/she can create or use an existing analytic widget that allows the student to select which mistake he/she made at that step. In addition, the student can add comments at each step in a free format textbox. The student does not have to follow each step of the prepared solution in his/her solution. The steps provide a means for capturing where mistakes are made and to show students a logical way of solving the problem. The instructor can select pre-existing widgets from a library of widgets or create his or her own for a selected part of the solution.

When the instructor finishes the creation of the question and attaching analytic widgets to particular solution elements, the form can be submitted and the question and all components of the question are stored in a database. The question is then viewable on the instructor's and student's dashboard. A hyperlink to the question is also generated and can be distributed to students or shared or embedded in other applications. The Question Creator will provide an instructor with the option of sharing a prepared question with others or clone or use an existing problem from the product's library.

When a student visits a question via the Student Dashboard 600 following a hyperlink to the question given by the instructor in or out of class, he/she is presented with the question text and an input area for the answer within a form element in the Question Presenter 610. The student solves the problem or activity, inputs the answer or answers and submits the form. The answer box is a free form textbox allowing for the submission of a single or multiple alphanumeric answers. For example, a question can have multiple parts and each part can have either a numeric or an alphabet answer.

The Prompter 620 is activated immediately on submission of the answer. The student's answer is compared to the answer stored in the database for that particular question. The student is presented with a new page that displays whether or not he/she answered the question correctly and the correct answer. The student is then presented with the learning outcome/concept behind the question; all other parts of the solution are initially hidden.

The outcome/concept behind the question gives an instructor the opportunity not only to state learning outcomes or objectives but to re-present the important concepts/principles for learning reinforcement. To view the next part of the solution, the student must answer all analytic widgets 508 attached to the preceding solution elements 507. This incentivizes the student to self-report any mistakes made and supports self-regulated learning strategies. If the student made an error that is not an option in an analytic widget, the student is able to input free text in a textbox to describe what error he/she made or describe alternative methods he/she used for solving the problem. The responses to the Prompter will be stored in a database with an associated timestamp.

When a student has answered the last analytic widget (if any) of the last solution element of the problem, he or she can view the Analytics 800 associated with the question for the entire class. The student can assess how he/she performed relative to his/her peers and make self-regulated learning adjustments as necessary. In addition, the student can rate the difficulty of the question and then choose to work on another similar question. The Analytics will be able to support multiple types of analytics such as basic statistics of percentage of students who got the problem right or wrong, mean, median, mode, standard deviation, maximum, and minimum scores, a frequency chart of the answers submitted, a plot showing the various answers that were submitted, the percentage of students that submitted each answer, a table showing the time each student took to answer the question with rows containing students who got the question correct highlighted in a different color from other rows, a chart of the percentage of students who understood the learning outcome/concept behind the question (if any), a chart of the percentage of students who understood each step of the solution, charts of the percentage of students that made each type of error associated with an analytic widget (which, in turn, is associated with a particular step), historical/trend analytics showing how students performed on groups of questions over a period of time, location analytics showing plots of location versus students' performances, temporal analytics charting students' performances as a function of the time of day they attempted the problem and students difficulty rating of a problem compared with difficulty rating preset by the instructor.

By analyzing and interpreting this data, an instructor can determine the success factors for his/her class and future classes, immediately review any areas of learning difficulties, make modifications to teaching strategies, course content and curriculum, and identify any at-risk students.

Various modifications of the invention, in addition to those described herein, will be apparent to those skilled in the art from the foregoing description. Such modifications are also intended to fall within the scope of this application.

YourLabs Correlation Engine

The YourLabs Correlation Engine, hereforth known as YLCE, is an automatic data trend tool for predicting student academic behavior and finding statistical correlation among student data across the problem, assignment, classroom, district, and state. The YLCE is a capable technology with its primary focus on finding trends among student data that is otherwise non-intuitive and displaying the results to the end-user in a minimally complex interface.

The YLCE uses traditional means of correlating data through common rankings via Pearson and Cramer. Graphs are made available to the end-user through 2D (x-y) and 3D (x-y-value) representations. Heat maps are also made available, but for different data representations e.g. ranking distances via t and ks-tests.

One of the core components of the YLCE is its prediction capabilities. By looking at the past performance of a student, the YLCE is able to notify the teacher of any potential future learning issues. These predictions are made through “Student Learning Features”. Examples of these features are the student's performance on a particular standard, the overall scores in the classroom, of a subject, or a particular standard. The YLCE collects temporal data and deduces relationships that relate to a student's time to solve a particular problem or time spent solving follow-up questions.

Predictions are made available through two interfaces: regression and classification. The YLCE regression interface provides values through multiple regression analysis models, such as support vector machines, principal components, simple regression, and linear regression. Errors of estimation are visually made apparent through linear or least squares annotations.

The YLCE provides classification answers by utilizing the collected binary-like widget data to classify how a student may respond to future problems. Questions such as “Did you understand this problem?” coupled with the category, or the standard, of a problem provide a way of predicting how a student will respond relative to their peers.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. Any reference numbers recited in the claims are exemplary and for ease of review by the patent office only, and are not limiting in any way. In some embodiments, descriptions of the inventions described herein using the phrase “comprising” includes embodiments that could be described as “consisting of”, and as such the written description requirement for claiming one or more embodiments of the present invention using the phrase “consisting of” is met.

What is claimed is:

1. An electronic learning system, which allows instructors to collect, process, evaluate, report, visualize, analyze, and share learning data from students, comprising:
a. a question creation module (510), configured to allow an instructor to create a question and store it in a library, wherein the question comprises a problem and a solution, wherein the solution comprises one or more solution steps and alternative answers, wherein each step may be associated with an analytic widget;
b. at least one analytic widget, configured to be assigned to a particular question, answer, or solution step, wherein an analytic widget is an HTML form element that solicits a student's response;
c. a question presenter (610), configured to retrieve a question from a library, and display a question to the student;
d. a question prompter (620), which prompts the student to enter a solution or solution step, wherein the solution may be in the form of mathematic equations, computer code, text, images, or multimedia data, compares the solution to the correct solution associated with the question, presents the student with an analytic widget associated with the solution or solution step, receives the student's response, and stores it in the library; and
e. the library (700), capable of storing and retrieving the questions, solutions, and students responses to solution steps and analytic widgets;
whereupon, the instructor uses the question creator (510) to create a question, whereupon the instructor enters the text of the problem, and further enters a step by step solution to the problem, whereupon, for each step, the instructor enters step by step alternative correct and incorrect solutions, whereupon the instructor selects an analytic widget to assign to each step, whereupon the question and all associated widgets and stored in a library (700), whereupon the student selects a question, whereupon the question is retrieved from the library (700), whereupon the question presenter (610) displays the question text to the student, whereupon the student enters a solution step, whereupon the prompter (620) compares the solution step to the correct solution, whereupon at each step the prompter informs the student as to the correctness or incorrectness of his answer, whereupon the student is presented with a learning outcome or concept, and is directed to review material and/or retake the question, whereupon the process is repeated until the student completes all steps in the solution.

2. The learning system of claim 1, where the system further comprises:
a. an instructor dashboard (500), comprising:
i. a class creation and editing module, configured to allow an instructor to create and edit a class and store it in a library (700);
ii. a list of existing classes, configured to link to an instructor class room dashboard for that class;
b. at least one instructor class room dashboard, comprising:
i. an assignment creation and editing module, configured to allow the instructor to create assignments and store them in the library (700), where the assignments comprise one or more questions and associated analytic widgets, and to allow the instructor to edit an assignment;
ii. a list of assignments, configured to link to an assignment dashboard for each assignment; and
iii. an instructor analytics module (800), configured to allow the instructor to view analytic data about student performance on the assignments, questions, and analytic widgets;
c. at least one instructor assignment dashboard comprising a list of questions in the assignment;
d. a student dashboard (600), comprising:
i. a class list, configured to list all classes the student is enrolled in, where each item in the class list is linked to a student class room dashboard; and
ii. a class enrollment module, configured to allow the student to enroll in a class;
e. a student classroom dashboard comprising:
i. a list of assignments, configured to link to an assignment dashboard for each assignment; and
ii. a student analytics module 800, configured to provide analysis to the student of his or her performance relative to other students;
f. a student assignment dashboard comprising a list of questions in the assignment, configured to link to questions, and to open a question presenter for each question;
whereupon, using the instructor dashboard (500), the instructor selects the class creation module, whereupon the instructor creates a class, whereupon the class is stored in the library, whereupon a classroom dashboard is created, and a link to the classroom dashboard is placed on the instructor dashboard, whereupon the instructor clicks on a clink and is taken to the classroom dashboard, whereupon using the class room dashboard, the instructor creates an assignment, whereupon a link to the assignment is placed on the classroom dashboard, whereupon from the assignment dashboard, the instructor uses the question creator (510) to create a question, whereupon the instructor enters the text of the problem, and further enters a step by step solution to the problem, whereupon, for each step, the instructor enters step by step alternative correct and incorrect solutions, whereupon the instructor selects an analytic widget to assign to each step, whereupon the question and all associated widgets and stored in a library (700), whereupon using the student dashboard, the student selects the class from the student dashboard (600), whereupon the student selects the assignment from the student class room dashboard, whereupon the student selects a question from the assignment dashboard, whereupon the question is retrieved from the library (700), whereupon the question presenter (610) displays the question text to the student, whereupon the student enters a solution step, whereupon the prompter (620) compares the solution step to the correct solution, whereupon at each step the prompter informs the student as to the correctness or incorrectness of his answer, whereupon the student is presented with a learning outcome or concept, and is directed to review material and/or retake the question, whereupon the process is repeated until the student completes all steps in the solution, whereupon the analytics module (800) in the student dashboard displays analytics describing the student's performance and the performance of the entire class to the student, whereupon the instructor views the instructor analytics module (800) to analyze class performance, whereupon the instructor views individual analytics widgets to identify student performance on specific solution steps.

3. The learning system of claim 1, where the system further comprises a user registration and login system, wherein the student and instructor register (301) at a registration page (302), with a username and password, whereupon the registration information is stored in the database (303), whereupon the user is presented with a login page (400), whereupon the student and instructor login with the username and password before reaching their respective dashboards (500,600).

4. The learning system of claim 2, where the class comprises:
a. a title;
b. an alphanumeric code;
c. an institution;
d. a semester;
e. a grade level;
f. a year;
g. a course material; and
h. one or more assignments and associated analytic widgets, where the class is stored in a library, where the assignments comprise a list of questions.

5. The learning system of claim 2, where the class creation module is further configured with:
a. means to import, add, and delete, students from the class roster;
b. means to import questions from an external source, such as a MS Word Doc, HTML, XML, Mathematica or other source;
c. means to delete a class;
d. means to export a class, in various output formats, including comma separated values or plain text; and
e. means to share a class with another user.

6. The learning system of claim 2, where the assignment creation module is further configured to allow:
a. means to add and remove questions from the assignment;
b. means to delete an assignment;
c. means to export an assignment, in various output formats, including comma separated values or plain text; and
d. means to share an assignment with another user.

7. The learning system of claim 1, where the question creation module is further configured to allow:
a. means to add and remove steps from the question;
b. means to add and remove analytic widgets from steps in the question;
c. means to import questions from an external source, such as a MS Word Doc, HTML, XML, Mathematica or other source;
d. means to delete a question;
e. means to export a question, in various output formats, including comma separated values or plain text; and
f. means to share a question with another user;

8. The learning system of claim 1, where the question creator is a web-based form comprising inputs:
a. a question title (501);
b. a question author;
c. question attributes;
d. question text (504);
e. question assets such as HTML, graphics, video, or other static or multimedia files;
f. question answer (505);
g. question learning outcome or concept (optional);
h. a step-by-step question solution (506,507);
i. at least one analytic widget (508); and
j. a question difficulty rating (503);
wherein, for inputs d-h, the instructor my enter hyperlinks, graphics, sounds, mathematical equations, HTML, video and other multimedia components from external sources, or from a library, wherein the question attributes may include items such as the number of attempts a student can make for the question (1 through unlimited), learning standards such as Common Core State Standards or ABET standards, wherein instructors can select standards from a dropdown list or search for standards using keywords.

9. The learning system of claim 1, where the analytic widgets are HTML form elements including, but not limited to radio buttons, checkboxes, and dropdown menus, that track where the student made errors and what types of errors were made at each step of the solution, wherein, when the student enters a solution, step, the student is presented with an analytic widget, where the student selects an option, and the student's response is saved and stored in the database and made available to the instructor.

10. The learning system of claim 2, where the instructor dashboard further comprises an analytic widget creation module, where the analytic widget is created via a form with inputs for widget title, widget label, widget type, widget options, and widget description, wherein when the form is submitted the input is transformed into an HTML element which is then appended to the selected part of the solution, wherein the analytic widget is saved to the library whereupon the instructor may share the analytic widget with any other user.

11. The learning system of claim 2, where the analytics module displays data consisting of numerical or graphical representations of statistics about the class, assignment, question, question steps, and analytic widgets, such as a mean, standard deviation, median, histogram, table, list, chart, historical trend, geo-locational trend, temporal analytics, difficulty rating, and others, wherein the analytics may be calculated at the question, assignment, class, instructor, school, district, state, and country level, wherein analytic data may be shared with other users or across the system.

12. The learning system of claim 2, where the instructor dashboard further comprises a sharing and collaboration module, which is configured to permit the instructor to share class data and analytic data on questions, assignments, courses, or students, with any other user.

13. The learning system of claim 1, where the question prompter is also configured to prompt the student to rate the difficulty of the question, after the solution is completed.

14. The learning system of claim 1, where the system is implemented using a networked client-server architecture comprising:
a. a server (100), comprising:
i. a server microprocessor (101), configured to receive information from a user terminal (200);
ii. a server storage (102), operatively connected to the server microprocessor;
iii. a server network communication hardware (104), operatively connected to the server microprocessor;
b. at least one user terminal (200), operatively connected to the server, comprising:
i. a client microprocessor (201), capable of displaying an instructor dashboard or a student dashboard;
ii. a display (203), operatively connected to the client microprocessor;
iii. a client storage (204), operatively connected to the client microprocessor;
iv. an input means (205), operatively connected to the client microprocessor; and
v. a client network communications hardware (202), operatively connected to the client microprocessor.

15. An electronic learning system, which allows instructors to collect, process, evaluate, report, visualize, and analyze learning data from students, comprising:
a. means for creating a question (510);
i. means for displaying a web-based form;
ii. means for accepting input from an instructor to each element in the web-based form;
iii. means for storing the content entered into the web-based form to a database so that it can be retrieved later;
iv. means for allowing the instructor to attach analytic widgets to question solutions or solution steps, the analytic widgets comprising elements that solicit a student self-reported learning response;
b. means for allowing a student to retrieve a question from the database (303);
c. means for displaying a question to a student (610);
d. means for implementing the question prompter (620), comprising:
i. means for accepting a first solution step input from the student;
ii. means for comparing the first solution step input to the correct solution step;
iii. means for displaying an analytic widget associated with the solution step to the student;
iv. means for accepting student self-reported learning data from the widget;
v. means for storing the student's solution step input and the analytic widget leaning data to the database;
vi. means for repeating steps (i)-(v), until all solution steps are completed;
e. means for implementing the database (303) where questions, solutions, analytic widgets, and student responses and learning data are stored and retrieved; and
f. means for retrieving and display analytic data (800) about the students responses to questions and analytic widgets form the database;
wherein the instructor creates a question, whereupon, for each step in the solution, the instructor selects one or more analytic widgets to assign to each step, wherein upon submitting the form, the question and all associated widgets are stored in the database (303), whereupon when the student selects the question, the question is retrieved from the database, whereupon the question presenter displays the question text to the student (610), whereupon the student enters a solution step, whereupon the prompter (620) compares the solution step to the correct solution, whereupon the prompter informs the student as to the correctness or incorrectness of his answer, whereupon the student is presented with an analytic widget, whereupon the student enters a response to the analytic widget, whereupon the process is repeated until the student completes all steps in the solution, whereupon all student responses are stored in the database (303), whereupon the instructor views the instructor analytics module (800), whereupon the analytics module retrieves the student responses from the database, whereupon the analytics module displays data about all student responses.

16. An electronic learning system, which allows instructors to collect, process, evaluate, report, visualize, and analyze learning data from students, comprising:
a. means for displaying an instructor dashboard (500), the instructor dashboard comprising:
i. a question creation module (510), which allows the instructor to create new questions;
ii. an instructor analytics module (800), which allows the instructor to view learning data based on the responses to questions;
b. means for implementing the question creation module (510), comprising:
i. means for displaying a web-based form;
ii. means for accepting input from the instructor to each element in the web-based form;
iii. means for storing the content entered into the web-based form to a database so that it can be retrieved later;
iv. means for allowing the instructor to attach analytic widgets to question solutions or solution steps, the analytic widgets comprising elements that solicit a student self-reported learning response;
c. means for displaying a student dashboard (600) comprising a means for directing students to a list of questions;
d. means for allowing a student to retrieve a question from the database (303);
e. means for displaying a question to a student (610);
f. means for implementing the question prompter (620), comprising:
i. means for accepting a first solution step input from the student;
ii. means for comparing the first solution step input to the correct solution step;
iii. means for displaying an analytic widget associated with the solution step to the student;
iv. means for accepting student self-reported learning data from the widget;
v. means for storing the student's solution step input and the analytic widget leaning data to the database;
vi. means for repeating steps (i)-(v), until all solution steps are completed;
g. means for implementing the database (303) where questions, solutions, analytic widgets, and student responses and learning data are stored and retrieved;
h. means for allowing the instructor to retrieve and display analytic data (800) about the students responses to questions and analytic widgets form the database, and
i. means for allowing the student to view analytic data (800) about his performance and the performance of the class as a whole;
whereupon, using the instructor dashboard (500), the instructor creates a question and, whereupon the instructor enters the text of the problem into a web-based form, and further enters a step by step solution to the problem, whereupon, for each step, the instructor selects one or more analytic widgets to assign to each step, whereupon the question and all associated widgets and stored in the database (303), whereupon the student selects the question from the student class room dashboard (600), whereupon the question is retrieved from the database, whereupon the question presenter displays the question text to the student (610), whereupon the student enters a solution step, whereupon the prompter (620) compares the solution step to the correct solution whereupon at each step the prompter informs the student as to the correctness or incorrectness of his answer, whereupon the student is presented with an analytic widget, whereupon the student enters a response to the analytic widget, whereupon the process is repeated until the student completes all steps in the solution, whereupon all student responses are stored in the database (303), whereupon the analytics module (800) in the student dashboard displays analytics describing the student's performance and the performance of the entire class to the student, whereupon the instructor views the instructor analytics module (800) to view class performance, whereupon the analytics module retrieves the student responses from the database, whereupon the analytics module displays data about all student responses.

17. The learning system of claim 16, where the question creation module comprises a web based form with the following elements:
a. a question title (501);
b. a question author;
c. question attributes (502);
d. question text (504);
e. question assets such as HTML, graphics, video, or other static or multimedia files;
f. question answer (505);
g. question learning outcome or concept (optional);
h. a step-by-step question solution (506, 507);
i. at least one analytic widget (508); and
j. a question difficulty rating (503);
wherein the question attributes may include items such as the number of attempts a student can make for the question (1 through unlimited, learning standards such as Common Core State Standards or ABET standards, wherein instructors can select standards from a dropdown list or search for standards using keywords.

18. The learning system of claim 16, where the system further comprises:
a. means for registering users (301), wherein the instructors and students create a username and password associated with a personal account;
b. means for prompting a user with a login (400), comprising:
i. a username, and
ii. a password;
c. means for verifying the correct password for the username entered;
wherein a user enters the username and password, whereupon, if the password is correct, if the user is a student, the user is directed to the student dashboard (500), and if the user is an instructor, the user is directed to the instructor dashboard (600).

19. The learning system of claim 16, where the instructor dashboard further comprises a class creation and editing module, where the system further comprises:
a. means for creating a new class, wherein a class comprises:
i. a title;
ii. an alphanumeric code;
iii. an institution;
iv. semester;
v. a grade level;
vi. year;
vii. course material, included uploaded files;
viii. one or more assignments and associated analytic widgets, wherein the class is stored in a library;
b. means for deleting a class;
c. means for editing a class;
d. means for exporting a class;
e. means for sharing a class;
f. means for displaying an instructor classroom dashboard;
g. means for creating a new assignment, and adding it to a class, where an assignment comprises a group of questions, comprising:
i. means for displaying an assignment creation form; and
ii. means for adding questions to the assignment; and
iii. means for importing a question;
h. means for exporting an assignment,
i. means for editing an assignment;
j. means for deleting an assignment; and
k. means for sharing an assignment;
whereupon, when the instructor selects the option to create a class, the instructor enters a class name and alphanumeric code, whereupon when the form is submitted the form information is validated and stored in a database, whereupon the class is added as a hyperlink to the dashboard, whereupon, when the instructor clicks on the class the instructor is taken to the class room dashboard, whereupon, when the instructor clicks on the button to create an assignment, the instructor is directed to an assignment creation form, whereupon, when the form is committed, the assignment is added as a hyperlink to the class room dashboard, whereupon, when the instructor clicks on the assignment hyperlink, the assignment is presented with an assignment editing page, whereupon the instructor is presented with the question creation module, whereupon after completing the question creation module, the question is added as a hyperlink to the assignment page.

20. The learning system of claim 16, wherein the system further comprises:
a. means for displaying an instructor classroom dashboard, the instructor classroom dashboard comprising:
i. a list of assignments,
ii. means for creating a new assignment, the assignments comprising a list of questions;
b. means for displaying an instructor assignment dashboard, comprising:
i. a list of questions;
ii. a link to the question creation module;
iii, a link to importing a question module;
c. means for importing a question;
d. means for displaying a student classroom dashboard, comprising a list of assignments;
e. means for displaying a student assignment dashboard, comprising a list of questions.

21. The learning system of claim 16, where the student dashboard comprises:
a. a list of classes the student is enrolled in;
b. means for adding or dropping a class;
c. means for displaying a student classroom dashboard, comprising:
i. a list of assignments for the class;
ii. means for displaying an assignment, comprising a list of questions;
iii. an analytics module; and
d. means for displaying class analytic data to the student;
whereupon, when the student selects the option to add or drop a class, the class is added as a hyperlink to the student dashboard, whereupon clicking on the link, the student is taken to the student classroom dashboard, whereupon, when the student clicks on assignment link, the list of questions is displayed, whereupon, when the student clicks on a question the student is taken to the questions presenter and question prompter for that question, whereupon, after completing the question, the student may select the analytics module, whereupon the analytics module displays performance data of the student and the class as a whole.

22. The learning system of claim 16, where the instructor dashboard further comprises means to permit the instructor to share class data with other users in the system, wherein, after sharing data, the analytics module reports statistics on students' performance at a problem level, assignment level, class, school, district, state and country level, as directed by the user.

23. The learning system of claim 16, where the analytic widgets are HTML form elements such as a radio buttons, checkboxes, dropdown means, that track where the student made errors and what types of errors were made at each step of the solution, wherein, when the student enters a solution, step, the student is presented with an analytic widget, where the student selects an option, and the student's response is saved and stored in the database and made available to the instructor.

24. The learning system of claim 18, where the instructor dashboard further comprises means to create an analytic widget, where the analytic widget is created via a form with inputs for widget title, widget label, widget type, widget options, and widget description, wherein when the form is submitted the input is transformed into an HTML element which is then appended to the selected part of the solution, wherein the analytic is stored in the database, wherein the instructor may share the analytic widget with other users.

25. The learning system of claim 16, where the analytics module displays data consisting of numerical or graphical representations of statistics about the students' performance in the class, assignment, question, solution steps, and responses to analytic widgets, including, but not limited to the mean, standard deviation, median, histogram, table, list, chart, historical trend, locational trend, temporal analytics, and difficulty rating, wherein the analytics may be calculated at the question, assignment, class, instructor, school, district, state, and country level.

26. The learning system of claim 16, where the instructor dashboard further comprises means to permit the instructor to share class, assignment, question, and analytic data with any other user.

27. The learning system of claim 16, where the question prompter is also configured to prompt the student to rate the difficulty of the question, after the solution is completed.
